(19) United States
(12) Patent Application Publication
(10) Pub. No.: US 2003/0172110 A1
(43) Pub. Date: Sep. 11, 2003

(54) Methods and apparatus for invoking a document style server operation using an operation name in a SOAPAction header

(75) Inventor: Sunil Kunisetty, Fremont, CA (US)

Correspondence Address: CHARLES G. CALL, 68 HORSE POND ROAD, WEST YARMOUTH, MA, 02673-2516, US

(73) Assignee: Oracle International Corporation

(21) Appl. No.: 10/315,869

(22) Filed: Dec. 10, 2002

(51) Int. Cl. G06F 15/16

(52) U.S. Cl. 709/203

(57) ABSTRACT

A document style operation performed by a service provider is immediately invoked at a server by placing a SOAPAction value that requests that operation in an HTTP SOAP request message. The SOAPAction value is a two-part string, the first part of which indicates that the SOAPAction value contains the specification of a desired operation, and the second part of which uniquely identifies that operation. When the HTTP server that provides the Web service receives the HTTP request, the SOAPAction header is evaluated to determine whether the first part is present and, if it is, the second part is used to directly identify and call a specified operation. The SOAP envelope portion of the request message contains any argument data that is to be passed to the designated procedure. The SOAPAction value may be obtained from an available WSDL service description disseminated by the service provider.

### FIELD OF THE INVENTION

This invention relates to distributed data processing systems and more particularly to Web services.

### BACKGROUND OF THE INVENTION

A Web service is a software application that supports direct interactions with other software applications using XML based messages transmitted via internet-based protocols. A Web service is identified by a uniform record identifier (URI) and has interfaces and a binding that are capable of being defined, described and discovered using XML artifacts.

Web services are commonly invoked by transmitting an XML request message to a remote server. The request message operates as a “remote procedure call“which specifies a specific procedure to be performed by the remote server and further contains any “argument” data which is to be supplied to the specified procedure. The XML request message, as well as the XML response returned from the remote server, are commonly “SOAP” messages which conform to the SOAP 1.1 specification. A SOAP request message is expressed in XML and typically includes information specifying the particular procedure to be executed and any arguments to be supplied to that procedure.

Although SOAP messages may be transmitted in a variety of ways, the Hypertext Transport Protocol (HTTP) is by far the most common method used to exchange SOAP messages. The SOAP 1.1 specification designates the semantics to be used to transmit SOAP messages over HTTP. The SOAP request message is posted to the HTTP server as an HTTP request and the server returns the SOAP response message as an HTTP response.

In common practice, when the HTTP SOAP request message is received at the server, a values string identifying the procedure to be executed is extracted from request message. This identification value is then used to access a stored description that conforms to the Web Service Description Language (WSDL). The accessed WSDL description contains the detailed information which the server requires to execute a specific procedure and pass any argument data contained in the SOAP message to that procedure. The WSDL description indicates the “style” of the SOAP message. There are two styles: RPC and document. RPC SOAP messages conform to the SOAP remote procedure call (RPC) convention and fully identify the procedure to be called and the parameters to be passed to that procedure. Document style SOAP messages, however, carry an arbitrary package of XML data. For document style SOAP service request messages, the identity of the procedure to be must typically be obtained from the WSDL service description.

The SOAP 1.1 specification defines a “SOAPAction” HTTP header which can convey a completely arbitrary value that is intended to tell the server what the SOAP message wants to do before the server decodes the SOAP XML. However, because the SOAPAction value is completely arbitrary, there is no certain way for the server to consistently know what to do without parsing the XML SOAP message and/or performing a lookup operation to obtain the WSDL description.

### BRIEF SUMMARY OF THE INVENTION

The present invention takes the form of methods and apparatus for using the SOAPAction HTTP header to specify a document style operation to be performed by the server so that the operation may be immediately and unambiguously invoked without performing a computationally burdensome process of retrieving and parsing a WSDL service description to obtain an identification of the operation to be invoked to perform the requested service.

In accordance with the invention, whenever a WSDL description of a particular Web service operation is produced, a SOAPAction value which unambiguously identifies the corresponding operation is also produced. This SOAPAction value is then placed in each HTTP SOAP message that requests that operation as a two-part string value, the first part of which indicates that the SOAPAction value contains the specification of a desired operation, and the second part of which uniquely identifies that operation. When the HTTP server that provides the Web service receives the HTTP request, the SOAPAction header is evaluated to determine whether the first part is present and, if it is, the second part is used to directly identify and call a specified operation. The SOAP envelope portion of the request message contains any argument data that is to be passed to the designated procedure.

The invention eliminates the need to retrieve and parse a WSDL service description in order to identify the requested operation when that operation is first requested, and eliminates the need to maintain a copy of the WSDL description at the Web server while, at the same time, being interoperable with operation invocation mechanisms used by others.

These and other features and advantages of the present invention may be more clearly understood by considering the following detailed description of the present invention. During the course of this description, frequent reference will be made to the attached drawings.

### BRIEF DESCRIPTION OF THE SEVERAL VIEWS OF THE DRAWING

FIG. 1 is a data flow diagram illustrating a conventional, prior art mechanism for invoking a procedure designated by an HTTP SOAP Web service request message;

FIG. 2 is a data flow diagram depicting an illustrative embodiment of the present invention in which a two-part SOAPAction HTTP header value is used to directly designate a desired Web service operation at runtime.

### DETAILED DESCRIPTION OF THE INVENTION

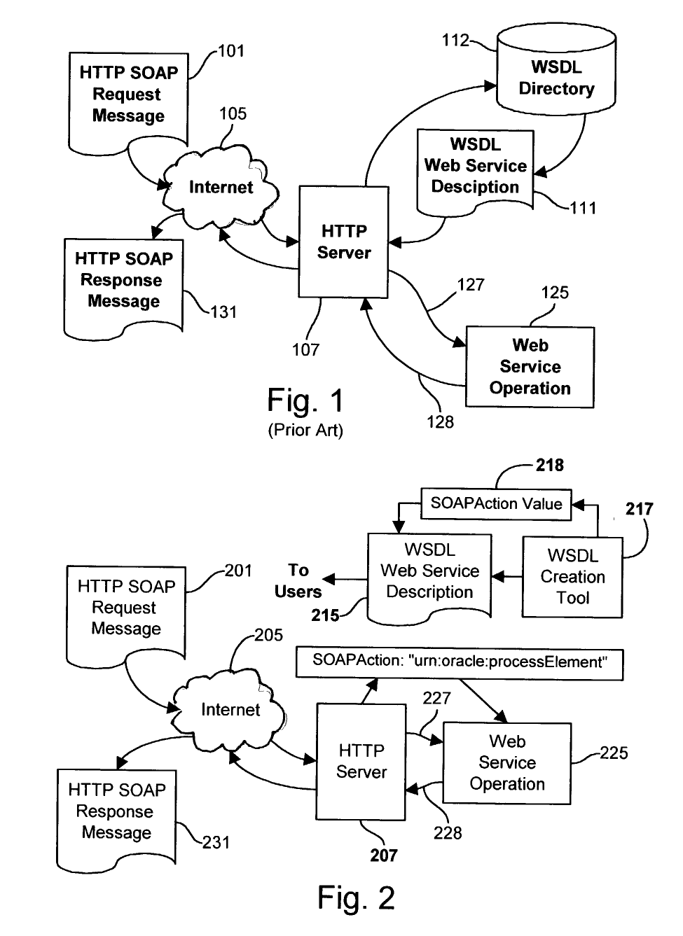

FIG. 1 of the drawings illustrates a conventional mechanism for performing a Web service using SOAP request (input) and response (output) messages transported via the Internet 105 using the HTTP protocol. The example Web service is a stock quote service that takes a ticker symbol as input and returns the current stock price as output and is defined the following illustrative WSDL service description set forth in the W3C Web Services Description Language (WSDL) 1.1 specification:

<?xml version=“1.0”?>
<definitions name=“StockQuote”
targetNamespace=“http://example.com/stockquote.wsdl”

xmlns:tns=“http://example.com/stockquote.wsdl”

[symbol]

xmlns:soap=“http://schemas.xmlsoap.org/wsdl/soap/”

[symbol]

<types>

[symbol]

[symbol]

xmlns=“http://schemeas.xm [symbol] org/wsdl/”>
<complexType>

<all>

<element name=“tickerSymbol” type=“string”/>

</all>

</complexType>

</element>
<element name=“TradePrice”>

<complexType>

<all>

<element name=“price” type=“float”/>

</all>

</complexType>

</element>

</schema>

</types>
<message name=“GetLastTradePriceInput”>

<part name=“body” element=“xsd1:TradePriceRequest”/>

</message>
<message name=“GetLastTradePriceOutput”>

<part name=“body” element=“xsd1:TradePrice”/>

</message>
<portType name=“StockQuotePortType”>

<operation name=“GetLastTradePrice”>

<input message=“tns:GetLastTradePriceInput”/>
<output message=“tns:GetLastTradePriceOutput”/>

</operation>

</portType>
<binding name=“StockQuoteSoapBinding” type=“tns:StockQuotePortType”>

<soap:binding style=“document”

transport=“http://schemas.xmlsoap.org/soap/http”/>

<operation name=“GetLastTradePrice”>
<soap:operation soapAction=“http://example.com/GetLastTradePrice”/>

<input>

<soap:body use=“literal”/>

</input>
<output>

<soap:body use=“literal”/>

</output>

</operation>

</binding>
<service name=“StockQuoteService”>

<documentation>My first service</documentation>

<port name=“StockQuotePort” binding=“tns:StockQuoteBinding”>

<soap:address location=“http://example.com/stockquote”/>

</port>

/service>

</definitions>

This WSDL definition above specifies the GetLastTradePricelnput and GetLastTradePriceOutput input and output messages, ties them to the operation named GetLastTradePrice, and defines a binding and a port for that operation. Note that the example WSDL definition includes a binding element that includes a style attribute:

<soap:binding style=“document”

which indicates that the request message has arbitrary XML content (in contrast to an RPC request message that will specify the operation to be performed). Note also that the WSDL description includes the operation name element and the soapAction element shown below:

<operation name=“GetLastTradePrice”>

<soap:operation soapAction=“http://example.com/GetLastTradePrice”/>

To use the StockQuoteService described by the forgoing example WSDL definition, the service user would transmit the following example SOAP input message embedded in an HTTP request as seen at 101 in FIG. 1 via the Internet 105 to a remote HTTP server 107 which provides the service:

POST /StockQuote HTTP/1.1
Host: www.stockquoteserver.com
Content-Type: text/xml; charset=“utf-8”
Content-Length: nnnn
SOAPAction: “Some-URI”

<soapenv:Envelope

xmlns:soapenv=“http://schemas.xmlsoap.org/soap/envelope/”>

<soapenv:Body>

<m:GetLastTradePrice xmlns:m=“Some_URI”>

<m:tickerSymbol>DIS</m:tickerSymbol>

</m:GetLastTradePrice>

</soapenv:Body>

</soapenv:Envelope>

In this example, the HTTP header SOAPAction value “Some_URI” is a uniform resource identifier (URI) that typically designates a WSDL definition 111 stored in a WSDL Directory seen at 112 in FIG. 1. In this example, the SOAPRequest specifies the operation GetLastTradePrice for a stock designated by the tickerSymbol “DIS” for Walt Disney Co. The server 107 uses SOAPAction value “Some_URI” to perform a lookup operation in the WSDL directory 112 to obtain the WSDL definition 111 that contains the information needed to identify and call a designated GetLastTradePrice operation 125 and pass the argument “DIS” parsed from the body of the SOAP input message 101 to the operation as seen at 127. The WSDL service description's soapAction element identifies the specific document type operation to be called. The result data produced when the called operation 125 is executed is then passed back to the server 107 as indicated at 129 where it is placed in a SOAP envelope and transmitted as an HTTP response message seen at 131 to the requestor. The content of the response message is illustrated in the following example:

HTTP/1.1 200 OK
Content-Type: text/xml; charset=“utf-8”
Content-Length: nnnn

<soapenv:Envelope xmlns:soapenv=“http://schemas.xmlsoap.org/soap/envelope/”>

<soapenv:Body>

<m:GetLastTradePriceResponse xmlns:m=“Some_URI”>

<m:price>34.5</m:price>

</m:GetLastTradePriceResponse>

</soapenv:Body>

</soapenv:Envelope>

Using this conventional technique, every incoming HTTP Web service request message is processed by performing a lookup operation to obtain a WSDL description which contains the operation name corresponding to the SOAPAction header value. The first invocation of the service is very slow because the WSDL description must be retrieved, parsed and browsed to obtain identify the desired operation. Thereafter, the lookup operation may be more rapidly performed by delivering the lookup result from a cache. It should also be noted that the value of the soapaction attribute in the WSDL may not be unique and hence uniquely mapping that value to an specific operation may not be possible.

The present invention takes the form of an improved method and apparatus for invoking Web services. In accordance with the invention, the HTTP request message used to invoke a particular Web service includes a SOAPAction value preferably consisting of a two-part value of having a format such as “urn:oracle:<operation-name>”. The second part “<operation-name>” is a literal string which specifies the designated operation to be performed and the first part “um:oracle” is a literal string used to inform the receiving server that the SOAPAction header value contains a direct reference to the desired operation. The literal string that makes up the first part of the SOAPAction string value plays two roles: it identifies the SOAPAction value as being a designation of the service operation to be invoked, and it further operates as a namespace name which insures the uniqueness and interoperability of the operation designation.

The use of this customized HTTP SOAPAction header eliminates the need to perform a lookup operation to fetch a WSDL service description at service runtime after the request is received. As a consequence, a Web server need not maintain a copy of the WSDL service description on the server side, there is no need to verify that a WSDL description exists, and there is no need to retrieve and parse a WSDL description in order to call and execute the desired operation.

An illustrative example illustrating the manner in which the invention is implemented is shown in FIG. 2 and described as follows:

First, a Web service operation (named “processElement” in the example below) is published as a document style (doc/literal) Web service that is be implemented on an HTTP Web server 207. A WSDL description 215 for the published service is generated by a conventional WSDL creation tool 217 provide to administer the Web server. Each time a new WSDL is created for a new Web service, the WSDL creation tool also places a unique soapAction attribute value in the WSDL service description as illustrated at 218. The resulting WSDL description is then made available for use by service requesters. The Web service operation 215 may implemented, for example, by a Java2 Enterprise Edition (J2EE)container written entirely in Java which executes on the standard Java Development Kit (JDK) included in the Oracle9i J2EE-certified Application Server, a product which integrates all of the technology required to develop and deploy e-business portals, transactional applications, and Web services into a single product. Oracle 9iAS is available from Oracle Corporation, 500 Oracle Parkway, Redwood Shores Calif., 94065.

In request messages sent by users, rather than using a HTTP SOAPAction header value that designates a WSDL service description, the SOAPAction header instead includes a direct reference to the “processElement” operation itself. As illustrated in FIG. 2, the Web server 207 evaluates the SOAPAction header value 230 extracted from the SOAP wrapper of the incoming request message, detects the presence of the string literal “um:oracle” in the SOAPAction header value that indicates that the remainder of the string value contains a direct identification of the “processElement” operation, and then directly invokes that operation without the need to retrieve, parse or evaluate a WSDL service description. The body of the SOAP request message 201 contains the argument value(s) that are passed as input parameter(s) in the call to the “processElement” operation 225 shown at 227. The operation 225 then generates result data at 228 that is placed in the envelope of an HTTP SOAP response message 231 which is returned to the requester via the Internet 205. The full content of an illustrative HTTP SOAP request message 201 is set forth below. Note specifically that the HTTP SOAPAction header contains the identification of the desired operation, but that the body of the SOAP message itself has contains only argument data and does not identify the operation, nor does the SOAP Body provide any indication of the operation name.

POST /stdoc/docservice HTTP/1.1
Host: dlsun991.us.oracle.com:6666
Connection: Keep-Alive, TE
TE: trailers, deflate, gzip, compress
User-Agent: RPT-HTTPClient/0.3-3
SOAPAction: “urn:oracle:processElement”
Accept-Encoding: gzip, x-gzip, compress, x-compress
Content-type: text/xml; charset=utf-8
Content-length: 711
<?xml version=‘1.0’ encoding=‘UTF-8’?>
<SOAP-ENV:Envelope xmlns:SOAP-
ENV=“http://schemas.xmlsoap,org/soap/envelope/”
xmlns:xsi=“http://www.w3.org/2001/XMLSchema-instance”
xmlns:xsd=“http://www.w3.org/2001/XMLSchema”>
<SOAP-ENV:Body>
<organisation>
<employee>

<name>Bob</name>
<emp_id>1234</emp_id>
<department>hr</department>
<contact>

<phone>827 644 5674</phone>
<email>bob@organisation.com</email>

</contact>

</employee>
<employee>

<name>Susan</name>
<emp_id>2434</emp_id>
<department>it</department>
<contact>

<phone>827 644 5674</phone>
<email>Susan@organisation.com</email>

</contact>

</employee>
</organisation>
</SOAP-ENV:Body>
</SOAP-ENV:Envelope>

The preferred method of sending the operation name of a doc/literal service as described above should be contrasted with the following alternative methods for designating a desired operation, all of which have disadvantages:

1) Using SOAPAction HTTP Header to send the operation name; e.g. using an HTPP SOAPAction header of the form: “SOAPAction: “processElement”. While this approach is very efficient, it is not interoperable because it does not provide a standard and unambiguous way of mapping the SOAPAction header value to the operation name.

2) Placing the SOAP message in an additional XML wrapper in which the wrapper name is either the operation name or an input message name. This approach is neither efficient nor interoperable.

3) Retrieving the operation name by using the SOAPAction header value in an WSDL lookup operation as described above in connection with FIG. 1. For example, using header of the form ‘SOAPAction: “foo”, a lookup operation may be used to retrieve a WSDL XML file and this WSDL file may be parsed to obtain the identification of the operation corresponding to the SOAPAction header value (“foo”). While this mechanism is interoperable provided that each operation has a corresponding unique SOAPAction value, it doesn't work if the SOAPAction value is does not uniquely designate a specific WSDL file. Moreover, it's inefficient because it is necessary to perform a lookup operation to retrieve the corresponding WSDL description, and then to parse that description to identify the operation to be performed by the server.

The SOAP protocol is continuing to evolve. On Jun. 26, 2002, the W3C issued a Working Draft of SOAP Version 1.2. In that draft, the fact that the SOAPAction header value as specified in SOAP 1.1 was arbitrary, and hence provided no way for the server to know the intent of the request without parsing the SOAP XML, was addressed by removing the SOAPAction header altogether. As specified in the draft of SOAP 1.2, “In the SOAP 1.2 HTTP binding, the SOAPAction HTTP header defined in SOAP 1.1 has been removed, and a new HTTP status code 427 has been sought from IANA for indicating (at the discretion of the HTTP origin server) that it is required by the server application. The contents of the former SOAPAction HTTP header are now expressed as a value of an ‘action’ attribute of the ‘application/soap+xml’ media type that is signaled in the HTTP binding.” Because the widespread use of SOAP 1.1 in existing Web service implementations, as well as in and associated tools and development software, the present invention is expected to be of continuing value even as newer protocols are adopted and used.

It is to be understood that the foregoing description of specific implementations of the invention are merely illustrative. Numerous modifications may be made to the methods and apparatus described without departing from the true spirit and scope of the invention.

What is claimed is:

1. The method of invoking the execution of a specific operation on a server computer from a client computer, said method comprising, in combination, the steps of:
at said client computer:
transmitting a SOAP request as an HTTP message from said client computer to said server computer, said message including a SOAPAction header which includes the header field designation character string “SOAPAction:” and an appended character string value comprising a first part that indicates that said appended character string value is an operation designation and a second part that identifies said specific operation, and
at said server computer:
receiving said HTTP message;
inspecting the SOAPAction header in said HTTP message to detect the presence of said first part, and
in response to the detection of the presence of said first part, invoking the execution of said specific operation identified by said second part of said SOAPAction header.

2. The method as set forth in claim I which includes the steps performed at said client computer prior to transmitting said HTTP message of:
obtaining service description data describing said specific operation and extracting an operation identification string value from said service description.

3. The method as set forth in claim 2 which further includes the step performed at said client computer prior to the transmission of said HTTP message of inspecting said operation identification string value to detect the presence of said first part that indicates that said character string includes an operation designation and, in response to the detection of said first part, placing said SOAPAction header including said identification string value in said HTTP message prior to transmission.

4. The method as set forth in claim 3 wherein said HTTP message further comprises a SOAP message envelope containing one or more parameters and wherein said method further comprises the steps performed at said server computer of extracting said one or more parameters from said SOAP message envelope and passing said one or more parameters to said service operation for processing.

5. Apparatus for invoking the execution of a specified operation on a remotely located server computer from a client computer, said apparatus comprising, in combination:
a communications pathway connecting said client computer to said server computer for transmitting HTTP request messages from said client computer to said server computer, a stored program executable on said client computer for transmitting an HTTP request message to said server computer, said HTTP request message including a SOAPAction header which includes the header field designation character string “SOAPAction:” and an appended character string value comprising a first part that indicates that said appended character string value is an operation designation and a second part that identifies said specific operation,
a transmission interface for transmitting said HTTP request message via said communications pathway to said server computer, and
a message handling program executable on said server computer for processing said HTTP request message for detecting the presence of a SOAPAction header which includes said first part and, in response to the detection of said first part, invoking the execution of said specific operation designated by said second part.

6. Apparatus as set forth in claim 5 wherein said HTTP request further comprises a SOAP message envelope containing one or more parameters and wherein said message handling program further includes means for extracting said one or more parameters from said SOAP message envelope and passing said one or more parameters to said service program for processing.

7. Apparatus as set forth in claim 5 further comprising storage means accessible to said client computer for storing service description data which includes said at least said second part that identifies said specific operation.

8. A Web service invocation system comprising, in combination,
a client computer,
a server computer,
a communications pathway for transmitting HTTP messages between said client computer and said server computer,
a stored service program executable on said server computer for performing a specified operation designated by a service designation,
service description data describing said specified operation stored at a location accessible to said client computer,
a stored client program executable on said client computer for transmitting an HTTP request message including a SOAPAction header to said server computer via said pathway, said SOAPAction header comprising the header field designation string “SOAPAction:” and a field value string comprising a predetermined literal string that indicates that the field value string is an operation designation and a second part which designates said specified operation, at least said second part being obtained from said service description data,
a message handling program executable on said server computer for receiving said HTTP request message and for invoking the execution of said stored service program to perform said specified operation in response to the detection of the presence of said predetermined literal string.

9. The Web service invocation system set forth in claim 8 wherein said service description data is expressed in the Web Service Description Language.

10. The Web service invocation system set forth in claim 8 wherein said HTTP request further comprises a SOAP message envelope containing one or more parameters and wherein said message handling program further includes means for extracting said one or more parameters from said SOAP message envelope and passing said one or more parameters to said stored service program for processing.
